(19) United States
(12) Patent Application Publication
(10) Pub. No.: US 2011/0236668 A1
(43) Pub. Date: Sep. 29, 2011

(54) Films Having Low Density and Low Haze

(76) Inventors: Michael J. Bader, Fairport, NY (US); Robert M. Sheppard, Victor, NY (US); Michael D. Cleckner, Rochester, NY (US); James A. Brooks, Williamson, NY (US); Jan M. Crum, Webster, NY (US); Lori A. Frauenhofer, Fairport, NY (US); Rene H. Doyen, Pittsford, NY (US); Leland L. Liu, Fairport, NY (US)

(21) Appl. No.: 13/063,520

(22) PCT Filed: Sep. 23, 2009
(86) PCT No.: PCT/US2009/058074

§ 371 Date: May 25, 2011

Related U.S. Application Data
(60) Provisional application No. 61/100,577, filed on Sep. 26, 2008.
(60) Provisional application No. 61/100,585, filed on Sep. 26, 2008.

(51) Int. Cl. B32B 27/08; B32B 3/26; B32B 27/10; B32B 15/08; C08J 5/18

(52) U.S. Cl. 428/304.4; 428/516; 428/513; 428/461; 264/172.12

(57) ABSTRACT

Disclosed are single and multi-layer films having low haze and low density properties, comprising at least one polymeric layer and at least one density reduction agent, wherein the film has a haze ≦35% and a density (D) of at least 1% lower than the density of the polymer. The density reduction agent may be added to, for example, a core layer, one or more tie layers, or a core layer and one or more tie layers. Processes for the manufacture of these films, and the use of these films as labels and packaging products are disclosed.

### CROSS-REFERENCE TO RELATED APPLICATIONS

This application claims priority from U.S. Provisional Application Ser. No. 61/100,577, filed Sep. 26, 2008, and U.S. Provisional Application Ser. No. 61/100,585, filed Sep. 26, 2008, the contents of which are incorporated by reference in their entirety.

### FIELD OF THE INVENTION

This invention relates to non-opaque, single and/or multi-layer films having low density and low haze properties comprising a layer, wherein the layer comprises at least one polymer and the at least one density reduction agent. The film including the layer has a haze ≦35% and a density (D) of at least 1% lower than a comparative film. The invention further relates to a process for the manufacture of these films, and to the use of these films as labels or packaging products, particularly for use in transparent packaging applications.

### BACKGROUND OF THE INVENTION

Polymeric films, especially polypropylene-based polymeric films, have application as labels and/or as flexible packaging for consumer goods. Labels made from such polymeric films are useful in part due to their printability, durability, and ability to conform and adhere to the surface of a package or container. Flexible packaging made from such polymeric films is useful for its light weight and ability to form hermetic seals.

To facilitate a “no label” look, many end-users prefer using non-opaque or near-transparent labels. In the flexible packaging market, there is a movement by end-users towards non-opaque and near-transparent packaging so that the packaged product may be readily seen without opening the package.

In addition, there is a current trend in the label market towards making labels and flexible packaging “eco-friendly” by reducing the amount of waste generated after the labeled or packaged items have been consumed. One method of doing this is to “down-gauge” the thickness of the films used to manufacture the label and flexible packaging. The problem with down-gauging is that it is difficult to maintain acceptable label and flexible packaging performance using thinner gauge propylene-based polymeric films.

Another method to reduce packaging waste is to reduce the density of films used to manufacture labels and flexible packaging. Film density may be reduced by introducing void spaces into the film's polymer matrix via cavitation. Conventional cavitation is well known in the art, wherein organic or inorganic cavitating agents or particles are dispersed within the polymer matrix in one or more layers of a polymer film. Exemplary organic, conventional cavitating agents may include polyesters, such as poly(ethylene terephthalate) (PET), poly(butylene terephthalate) (PBT), or mixtures thereof. Exemplary inorganic, conventional cavitating agents may include calcium carbonate (CaCO₃), barium carbonate (BaCO₃), clay, talc, silica, mica, titanium dioxide (TiO₂), or mixtures thereof.

The presence of the cavitating agent in a layer of a film induces voids or “cavities” in the polymeric material comprising the layer when the film is stretched during mono- or bi-axial orientation. During such orientation, voids are created at the site of the cavitating agent particles, creating a cavitated film. The voids in the cavitated film scatter light passing through the film, thereby causing the film to appear translucent, opaque or non-transparent.

All of the known low density cavitated films are translucent, opaque or non-transparent and have high haze and low light transmission optical properties. Therefore there is a need for a polymeric film that is non-opaque and/or near-transparent and having low density. The invention disclosed herein meets this and other needs.

### SUMMARY OF THE INVENTION

The present invention provides a film comprising a layer having a polymer and a density reduction agent, wherein the film has a haze ≦35% and a density (D) of at least 1%, preferably 2%, 5%, or 10% lower than the polymer.

The present invention also particularly provides a film having a haze ≦35% and a density (D)≦0.85 g/cm³ comprising one or more polymeric layer(s), wherein at least one of said one or more polymeric layer(s) comprises a polypropylene-based polymer and a density reduction agent.

Methods of making the non-opaque single and multi-layer films having low haze and low density properties of this invention are described.

Labels, films for packaging, and films for other typical polymeric film applications from any of such non-opaque single and multi-layer films are also described.

### DETAILED DESCRIPTION OF THE INVENTION

### Definitions

The term “non-opaque” as used herein and specifically in connection with the inventive films refers to the visual appearance of such film. A non-opaque film transmits substantially the entire visual light incident on a surface of the film and reflects, scatters, or absorbs very little of such visual light. The degree of non-opacity may be measured by one or more optical properties of a film, including, but not limited to, haze, light transmission or clarity.

The term “film yield” as used herein means the measurement of a film's surface coverage per unit weight. All film yields as used in this disclosure were measured by ASTM method D2673-99.

The term “polygauge” as used herein means the thickness of the film before it is cavitated. The polygauge of uncavitated film can be measured by ASTM method D6988. Polygauge of cavitated films referenced in this disclosure is calculated from yield and optical gauge measurements.

The term “optical gauge” as used herein means the thickness of the film after it is cavitated in the orientation process. All optical gauges as used in this disclosure were measured by a BETA Laser-Mike (Model# 283-20).

The term “Gurley stiffness” as used herein means the bending resistance of a flat sheet material by measuring the force required to bend a specimen under controlled conditions. The ASTM test is D6125-97.

The term “comparative film” means a film that does not include the density reduction agent. A comparative film is compositionally essentially the same as an inventive film and is made under essentially the same conditions by essentially the same method. In this context the term “essentially the same” means that the conditions and methods used to make the comparative and inventive films are the same within experimental error. With respect to the composition of a comparative film and an inventive film, the term “essentially the same” means that the amounts of the constituent components of a comparative film and an inventive film are the same within experimental error, accounting for any differences due to the absence of the density reduction agent.

### Haze

The term “haze” as used herein refers to the percentage of incident light that is transmitted through a film that is deflected or scattered more than 2.5 degrees from the incoming light direction. On the other hand, the term “light transmission” as used herein refers to percentage of incident light that passes through a film. The haze for a film may be measured with a spectrophotometer or hazemeter using ASTM method D 1003. In one or more embodiments, the haze value of the film is ≦35%. In other embodiments, the haze is ≦30%, ≦25%, ≦20%, ≦18%, ≦15%, ≦12%, ≦10%, ≦8%, ≦5%, ≦3%, or ≦2%.

### Clarity

The term “clarity” or “see-through quality” as used herein refers to the amount of light transmitted at angles of <2.5 degrees. Light is diffused in a narrow angle range with high concentration. This effect describes how well very fine details can be seen through the specimen. The clarity of a film may be measured using a BYK-Gardner Hazemeter Plus, which is also used to measure haze. ASTM test D 1746 describes a method of measuring regular transmittance or clarity.

### Film Density

Density is defined as the mass per unit volume and is usually expressed in units of g/cm³. Film density can be calculated from yield and optical gauge measurements using the following formula: Density (g/cm³)=1000/[yield (m²/kg)*optical gauge (μm)]. In one or more embodiments, the density of the film is at least 1%, 2%, 5%, 10%, 15%, 20%, 30%, 40%, 50%, 60%, 70% or 80% lower than the density of a comparative film.

### Density Reduction Agents

The term “density-reduction agent” as used herein refers to a material that may be added to a film layer which has the ability to reduce the overall density of the film. Such reduction of density is preferably effectuated upon mono-axial or biaxial orientation of the unoriented film; however, in some embodiments of the invention, film density may be reduced in an unoriented state.

The amount of the density reduction agent added to the polymeric layer of the inventive film is not particularly limited. In one or more embodiments, the density reduction agent comprises ≦20 wt. % based on the weight of the polymeric layer to which it is added. In other embodiments, the density reduction agent comprises <10 wt. %, 5 wt. %, or 1 wt. % based on the weight of the at least one polymeric layer.

The shape of the density reduction agent added to the polymeric layer of the inventive film is not particularly limited. In one or more embodiments, the density reduction agent comprises particles. Such particles may be spherical in shape and have a solid interior volume, or an interior volume than contains one or more hollow or void spaces. Such spherical particles may have a mean particle size ≦20 μm. Also, such particles may be non-spherical in shape (e.g., tubular or irregular) and have a solid interior, or an interior that contains one or more hollow or void spaces.

The material of the density reduction agent added to the polymeric layer of the inventive film is not particularly limited. In one or more embodiments, the density reduction agents include organic and inorganic compounds which are capable of creating void spaces in the polymeric layer upon mono- or bi-axial orientation. Organic compounds include, but are not limited to, thermoplastic-polymer, such as, polypropylene, polyesters, such as poly(ethylene terephthalate) (PET), poly(butylene terephthalate) (PBT), or mixtures thereof. Inorganic compounds include, but are not limited to calcium carbonate (CaCO₃), barium carbonate (BaCO₃), clay, talc, silica, mica, titanium dioxide (TiO₂), or mixtures thereof. In other embodiments, the density reduction agent particles may comprise glass, ceramic or metal or a combination thereof. The selection of the density reduction agent is depending on the type of polymer used for the layer to contain such density reduction agent.

Examples of commercially-available density reduction agents include, but are not limited to, 110P8 hollow glass spheres (commercially-available from Potter Industries, Inc.), Expancel (R) microspheres (commercially available from Akzo Nobel), and Oppera™ PA (commercially available from ExxonMobil Chemical Company).

### Refractive Index

The refractive index of the density reduction agent (R₂) is not particularly limited. In one or more embodiments, the density reduction agent has a refractive index (R₂) value ≦about 2.0, 1.5, 1.0 or 0.5. All refractive indexes used in this disclosure can be measured by using ASTM method D1218. The refractive index of the polymeric layer to which a density reduction agent is added is referred to as R₁. In one or more embodiments, the ratio of R₁ to R₂ (R₁/R₂) is selected from the group comprising of 1±0.25, 1±0.2, 1±0.1, 1±0.05, 1±0.025, 1±0.01, and 1±0.005.

The size (e.g., mean diameter) of the density reduction agent is not particularly limited. In one or more embodiments, the density reduction agent is a spherical particle having a mean diameter of ≦20 μm, 15 μm, 10 μm, 5 μm, or 1 μm.

### Wetting Agents

In order to further improve the optical properties, the film of this invention may further comprise a wetting agent. The wetting agent is in contact with at least a portion of the density reduction agent.

The type of wetting agent that may be used in this invention is not particularly limited. In one or more embodiments, suitable wetting agents include, but are not limited to, silicone oil, mineral oil, erucamide, silicone gum, surfactants and combinations thereof. In case of surfactants, suitable surfactants include, but are not limited to, an anionic surfactant, a cationic surfactant, a non-ionic surfactant, a zwitterionic (dual charge) surfactant or a combination thereof. In other embodiments, a suitable wetting agent comprises a silane.

While not being bound by any particular theory, it is believed that the wetting agent wets at least a portion of the surface of the density reduction agent to create an advantageously improved interface between the polymeric layer and density reduction agent. The improved interface results in less diffraction and more transmission of incident light, thereby providing less haze and improved light transmission.

### Polymeric Layers

The density reduction agent may be added to at least one polymeric layer of single layer films or multi-layer films.

In the case of a film having a single polymeric layer, the density reduction agent may be added in an amount of ≦20 wt. %, 10 wt. %, 5 wt. %, 1 wt. % based on the weight of the polymeric layer to which the density reduction agent is added.

In the case of multi-layer base films having at least two layers, the density reduction agent may be added to one or more layers of the multilayer film. The density reduction agent may be added to any such layers in an amount of ≦20 wt. %, 10 wt. %, 5 wt. %, or 1 wt. % based on the weight of the polymeric layer to which the density reduction agent is added. The amount of the density reduction agent is such that the multilayer film after orientation, has density of <99%, <90%, <80%, <70%, <60%, <50%, <40%, <30% of the density of a comparative multilayer film.

In one or more embodiments, any polymeric layer comprises at least one of a homopolymer, a copolymer, a terpolymer of a C₂ to C₈ alpha-olefin, a polyamide, a polyacetate, a polyester, a polycarbonate, a polystyrene, a poly(vinyl chloride), a poly(ethylene vinyl alcohol), a poly(vinyl alcohol), a poly(ethylene vinyl acetate), a poly(acrylic acid) and a poly(ethylene terephthalate), or a blend/mixture thereof. In some embodiments a polypropylene-based homopolymer or copolymer is used in combination with the density reduction agent. In other embodiments, a polyethylene-based homopolymer or copolymer (e.g. an LLDPE) is used in combination with the density reduction agent.

In one or more embodiments, the R₁/R₂ is selected from the group comprising of 1±0.25, 1±0.2, 1±0.1, 1±0.05, 1±0.025, 1±0.01, and 1±0.005. In one or more embodiments, the density reduction agent has a refractive index value ≦about 2.0, 1.5, 1.0 or 0.5.

One or more embodiments of the inventive single and multi-layer films of this invention may have utility in many other applications. Such applications include, for example, flexible packaging and labeling. In certain applications, the inventive films may be used for covering, and/or packaging of materials such as bottles, tubes and other cylindrical articles, especially bottles, tubes and cylindrical articles having a contoured shape. Heat-shrinkable embodiments of the invention are capable of shrinkage along a single axis without substantial shrinkage in the other axis. Such films may be suitable for application in the process of labeling bottles by shrinking a tube of heat shrinkable single or multi-layer film. Also, such films may be suitable for use in printing and other conversion processes which require heat stability in at least one direction, preferably both directions, to meet machinability requirements. Ideally, the films should not shrink during processing, handling and shipment; and preferably, the films shrink only when induced to shrink as by heating the film when it is applied to a surface to be used as a label, etc.

### Core Layers

The term “core layer” as used herein refers to the only layer of a single layer film or the thickest layer of a multi-layer film. In general, the core layer of a multilayer structure will be the innermost or more centrally positioned layer of the structure with respect to the other, more external layer(s) on one or each side of the core layer. It is understood that when a layer is referred to as being “directly on” another layer, no intervening layer(s) is/are present. On the other hand, when a layer is referred to as being “on” another layer, intervening layers may or may not be present.

The film includes a core layer. The core layer comprises a polymeric matrix containing a polymer.

### Tie Layers

The tie layer is positioned intermediate the core layer and other film layer, such as for example a skin layer. The tie layer of a multi-layer film is commonly used to connect two layers, such as two layers that might otherwise not bond well due to incompatibility issues. The tie layer may also provide some other functionality, such as barrier enhancement, antiblock particle support, to enhance sealability, machinability, or other benefits, as desired.

In some embodiments, the tie layer is in direct contact with the first surface of the core layer. In other embodiments, another layer or layers may be intermediate the core layer and the functional tie layer described herein.

### Additional Layers

In one or more embodiments, the non-opaque multi-layer films of this invention further comprise at least one additional layer disposed on an outermost surface of any polymeric layer. Such at least one additional layer includes, but is not limited to, a skin layer, a heat sealing layer, a laminatable layer, a printable layer and combinations thereof. In some embodiments, such any additional layer comprises a polymeric material. In other embodiments, such additional layers comprise papers, vacuum-deposited metals, foils, coatings or a combination thereof. Such coatings include protective coatings, heat sealing coatings, laminatable coatings, adhesive coatings, primer coatings, printable coatings or a combination thereof.

The polymeric resin used in the additional layer(s) is not particularly limited. In one or more embodiments, the additional layer(s) comprises any suitable polymeric material. Such polymeric material may comprise a homopolymer, a copolymer, a terpolymer or a blend of a C₂ to C₈ alpha-olefin, a polyamide, a polyacetate, a polyester, a polycarbonate, a polystyrene, a poly(vinyl chloride), a poly(ethylene vinyl alcohol), a poly(vinyl alcohol), a poly(ethylene vinyl acetate), a poly(acrylic acid) or a poly(ethylene terephthalate). In other embodiments, such additional layer(s) may be a polymeric material blended with polypropylene.

### Method of Making

The method for making the film of this disclosure having low haze and low density properties of this invention comprises:
(a) extruding a mixture of a polymer and a density reduction agent to form a layer, wherein said polymer comprises one or more of a homopolymer, a copolymer, a terpolymer or a blend of a C₂ to C₈ alpha-olefin, a polyamide, a polyacetate, a polyester, a polycarbonate, a polystyrene, a poly(vinyl chloride), a poly(ethylene vinyl alcohol), a poly(vinyl alcohol), a poly(ethylene vinyl acetate), a poly(acrylic acid) or a poly(ethylene terephthalate), and the density reduction agent comprises particles, the particles having an interior volume and a shape, the interior volume is substantially solid or substantially hollow, the shape is substantially spherical, tubular or irregular, and
(b) optionally, orienting the extruded layer in at least one direction; to form a film with a haze ≦35%, particularly ≦20%, and the density (D) of the film is at least 1% lower than the density of a comparative film.

In one or more embodiments, the film may comprise more than one layer, i.e., multilayer films. The extruding step (a) for a multilayer film is a co-extruding step. In such embodiments, where the film is a multilayer film, the resulting multilayer film preferably has a haze ≦35%, particularly ≦20%, and the density (D) of the film is at least 1% lower than the density a comparative film.

### Film Treatments

The outermost surface(s) of the non-opaque single and multi-layer films of this invention, including the outermost surface(s) of any additional layer(s), may be surface-treated by any suitable surface treatment known in the art to improve printing, adhesion of coatings and other layers. The specific type of surface treatment is not particularly limited. Such surface treatment(s) include flame treatment, corona treatment, plasma treatment and combinations thereof. Surface treatment may be in-line during film manufacture or off-line after the manufactured film has been wound on a spool. Following surface treatment, the surface-treated layer(s) may be printed, metallized, and/or laminated to a substrate or any combination thereof.

The surface-treated outermost surface(s) of the non-opaque single and multi-layer films of this invention, including the outermost surface(s) of any additional layer(s), may be metallized by any suitable metallization process known in the art. Such surface-treated surface or layer may be metallized by deposition of a metal selected from the group consisting of aluminum, silver, gold and combinations thereof. Alternatively, such outermost surfaces may be metallized without prior surface treatment.

The outermost surface(s) of the non-opaque single and multi-layer films of this invention, including the outermost surface(s) of any additional layer(s), may be laminated by any suitable process known in the art. Suitable lamination processes include, but are not limited to, extrusion lamination and adhesive lamination. Alternatively, such outermost surfaces may be laminated following any one of the surface treatments described above in order to improve adhesion.

### Film Orientation

The multi-layer film may be oriented by one or more conventional film orientation processes known in the art. Such film orientation processes include, but are not limited to, blown film processes, tenter frame processes, LISIM™ (e.g. simultaneous machine and transverse direction orientation), single bubble processes, double bubble processes and combinations thereof. In one or more embodiments, the non-opaque single and multi-layer films of this invention may be monoaxially-oriented, or biaxially oriented. In some embodiments, such films may not be oriented. If the case of mono-axial orientation, the film is at least monoaxially-oriented in a machine direction or a transverse direction. In the case of biaxial-orientation, the film is biaxially-oriented in a machine direction and a transverse direction, either sequentially or simultaneously. For sequential orientation, the film is oriented in the machine direction and then in the transverse direction, or it is oriented first in the transverse direction and then in the machine direction. For simultaneous orientation, the film is oriented in the machine direction and the transverse direction simultaneously.

The present invention will be further described with reference to the following nonlimiting examples.

### Particular Embodiments

1. Embodiments of the invention include a film, comprising one or more polymeric layer(s), wherein at least one of the one or more polymeric layer(s) comprises a polymer and a density reduction agent, wherein the film has a haze ≦35% and a density (D) of at least 1% lower than a comparative film, wherein the polymer is one or more of a homopolymer, copolymer, terpolymer and blends of a polymeric material, the polymeric material selected from the group consisting of a C₂ to C₅ alpha-olefin, a polyamide, a polyacetate, a polyester, a polycarbonate, a polystyrene, a poly(ethylene vinyl alcohol), a poly(vinyl chloride), a poly(vinyl alcohol), a poly(ethylene vinyl acetate), a poly(acrylic acid) and a poly(ethylene terephthalate).
2. In particular embodiments, the invention includes a film, comprising one or more polymeric layer(s), wherein at least one of the one or more polymeric layer(s) comprises a polymer and a density reduction agent, wherein has a haze ≦35% and a density (D) of at least 2%, preferably, at least 5%, or at least 10% lower than a comparative film, wherein the polymer comprises polyethylene, specifically polyethylene, particularly polyethylene having a density (D) where 0.850<D≦0.960 g/cm³, and/or polypropylene.
3. The film of paragraphs 1 or 2, wherein the polymeric layer which comprises the polymer and the density reduction agent has ≦20 wt. %, 10 wt. %, 5 wt. %, or 1 wt. % of the density reduction agent based on the weight of the polymeric layer which comprises the polymer and the density reduction agent.
4. The film of any of preceding paragraphs 1 to 3, wherein the density reduction agent comprises particles having an interior volume and a shape, the interior volume of the particles is substantially solid or substantially hollow, the shape of the particle is substantially spherical, tubular or irregular.
5. The film of any of preceding paragraphs 1 to 4, wherein the density reduction agent particles comprise polymer, glass, ceramic or metal or a combination thereof.
6. The film of any of preceding paragraphs 1 to 5, wherein the density reduction agent is a substantially spherical particle having a mean diameter of ≦a mean diameter value selected from a group consisting of 20 μm, 15 μm, 10 μm, 5 μm, and 1 μm.
7. The film of any of preceding paragraphs 1 to 6, wherein the film has a haze ≦30%.
8. The film of any of preceding paragraphs 1 to 7, wherein the density (D) of the film is ≦90% of the density of a comparative film.
9. The film of any of preceding paragraphs 1 to 8, wherein the density (D) of the film is ≦50% of the density of a comparative film.
10. The film of any of preceding paragraphs 1 to 9, further comprising a wetting agent, wherein the wetting agent is in contact with at least a portion of the density reduction agent. In particular embodiments, the wetting agent is selected from the group consisting of a silicone oil, a mineral oil, an erucamide, a silicone gum, a surfactant and combinations thereof.
11. The film of any of preceding paragraphs 1 to 10, wherein the surfactant is an anionic surfactant, a cationic surfactant, a non-ionic surfactant, a zwitterionic (dual charge) surfactant or a combination thereof. Such embodiments wherein the wetting agent comprises a silane may be particularly useful.
12. The film of any of preceding paragraphs 1 to 11, wherein the one or more polymeric layer(s) further comprises one or more of a homopolymer, copolymer, terpolymer and blends of a polymeric material, the polymeric material selected from the group consisting of a C₂ to C₈ alpha-olefin, a polyamide, a polyacetate, a polyester, a polycarbonate, a polystyrene, a poly(vinyl chloride), a poly(ethylene vinyl alcohol), a poly(vinyl alcohol), a poly(ethylene vinyl acetate), a poly(acrylic acid) and a poly(ethylene terephthalate).
13. The film of any of preceding paragraphs 1 to 12, further comprising at least one additional layer disposed on an outermost surface of the one or more polymeric layer(s).
14. The film of any of preceding paragraphs 1 to 13, wherein the additional layer is selected from the group consisting of a skin layer, a heat sealing layer, a laminatable layer, a printable layer and combinations thereof.
15. The film of any of preceding paragraphs 1 to 14 having a density of from 0.65 to 0.90 g/cm³.
16. The film of any of preceding paragraphs 1 to 15 having a density of from 0.65 to 0.85 g/cm³.
17. The film of any of preceding paragraphs 1 to 14 wherein the polymer is a polyester, and the density ranges from 1.0 g/cm³ to 1.25 g/cm³.
18. The film of any of preceding paragraphs 1 to 17, wherein the film is biaxially-oriented: (1) sequentially biaxially-oriented (a) in the machine direction and then the transverse direction or (b) in the transverse direction and then the machine direction; or (2) or simultaneously in the machine direction and the transverse direction.
19. Embodiments of the invention relate to a method for making the film of any preceding claim, comprising: (a) forming a mixture of the polymer and the density reduction agent; and (b1) extruding the mixture to form a polymeric layer; or (b2) co-extruding the mixture with additional polymeric material to form a multilayer film.
20. Particular embodiments of the method of paragraph 19 further comprise a step of orienting the film in machine direction, traverse direction or both to form a film having a haze ≦35% and a density (D)≦90% of the density of the polymer.
21. Particular embodiments of paragraph 20 include those wherein the polymer has a refractive index (R₁), the method comprising a step of selecting a density reduction agent having a refractive index (R₂) such that the ratio of R₁ over R₂ (R₁/R₂) is within a range selected from the group consisting of 1±0.25, 1±0.2, 1±0.1, 1±0.05, 1±0.025, 1±0.01, and 1±0.005.
22. Still other embodiments include those of paragraph 21 wherein the orientation step is accomplished by process selected from the group consisting of blown film process, tenter frame process, single bubble process, simultaneous machine and transverse direction orientation, double bubble process, and combinations thereof.
23. In still other embodiments, the invention relates to a film comprising one or more polymeric layer(s), wherein at least one of said one or more polymeric layer(s) comprises a polypropylene-based polymer and a density reduction agent, wherein the film has a haze ≦35% and a density (D)≦0.85 g/cm³.
24. Particular films of paragraph 23 have a haze ≦35%, particularly ≦about 20%, and a density (D) such that 0.50≦D≦0.85 g/cm³, particularly 0.60≦D≦0.85 g/cm³, more particularly 0.65≦D≦0.85 g/cm³. Some preferred films have a haze ≦20% and a density (D) such that 0.65≦D≦0.85 g/cm³. Particular embodiments have a haze ≦about 20% and a density (D) such that 0.65≦D≦0.85 g/cm³ Films of these embodiments may also be characterized by a clarity of at least 70%.
25. In particular films of the embodiments of paragraphs 23 or 24 the polypropylene-based polymer has a refractive index (R₁) and said density reduction agent has a refractive index (R₂), the ratio of R₁ over R₂ (R₁/R₂) is within a range selected from the group consisting of 1±0.25, 1±0.2, 1±0.1, 1±0.05, 1±0.025, 1±0.01, and 1±0.005.
26. In particular films of any of paragraphs 23 to 25, the film has ≦20 wt. %, 10 wt. %, 5 wt. %, or 1 wt. % of said density reduction agent based on the weight of the film which comprises said polypropylene-based polymer and said density reduction agent.
27. Embodiments of the films of any of paragraphs 23 to 26 may also include films wherein the density reduction agent comprises particles having an interior volume and a shape, said interior volume of said particles is substantially solid or substantially hollow, said shape of said particle is substantially spherical, tubular or irregular. Particularly useful particles comprise at least one of polymer particles, glass particles or beads, ceramic particles, or metal particles.
28. In particular films of any of paragraphs 23 to 27, the film of any preceding claim, wherein said refractive index (R₂) of said density reduction agent is ≦about 2.0.
29. Embodiments of the films of any of paragraphs 23 to 28, include those wherein the reduction agent is a substantially spherical particle having a mean diameter of ≦a mean diameter value selected from a group consisting of 20 μm, 15 μm, 10 μm, 5 μm, and 1 μm.
30. Embodiments of the films of any of paragraphs 23 to 29, include those wherein the film of any preceding claim, wherein the film has a haze value selected from a group consisting of ≦18%, ≦15%, ≦12%, ≦10%, ≦8%, ≦5%, ≦3%, and ≦2%.
31. The film of any of paragraphs 23 to 30, further comprising a wetting agent, wherein said wetting agent is in contact with at least a portion of said density reduction agent.
32. In particular films of paragraphs 23 to 31, wherein said wetting agent is selected from the group consisting of a silicone oil, a mineral oil, erucamide, a silicone gum, a surfactant and combinations thereof. In some films the surfactant is an anionic surfactant, a cationic surfactant, a non-ionic surfactant, a zwitterionic (dual charge) surfactant or a combination thereof. Particular wetting agents comprise a silane.
33. In particular films of paragraphs 23 to 32 said one or more polymeric layer(s) further comprises one or more of a homopolymer, copolymer, terpolymer and blends of a polymeric material, said polymeric material selected from the group consisting of a C₂ to C₈ alpha-olefin, a polyamide, a polyacetate, a polyester, a polycarbonate, a polystyrene, a poly(ethylene vinyl alcohol), a poly(vinyl chloride), a poly(vinyl alcohol), a poly(ethylene vinyl acetate), a poly(acrylic acid) and a poly(ethylene terephthalate). Some films further comprising at least one additional layer disposed on an outermost surface of said one or more polymeric layer(s), particularly where said additional layer is selected from the group consisting of a skin layer, a heat sealing layer, a laminatable layer, a printable layer and combinations thereof. In other embodiments said additional layer comprises a paper, a vacuum-deposited metal foil, a coating, a polymeric material or a combination thereof. In still other films, the coating is a protective coating, a heat sealing coating, a laminatable coating, an adhesive coating, a primer coating, a printable coating or a combination thereof.
34. The film of any of embodiments 23 to 33, wherein said film is biaxially-oriented in a machine direction and a transverse direction. In some embodiments, the biaxially-orientation includes: (1) sequentially biaxially-orientation (a) in said machine direction and then said transverse direction or (b) in said transverse direction and then said machine direction; or (2) or simultaneous biaxially-orientation in said machine direction and said transverse direction.
35. Embodiments of the invention also include a method for making the film of any preceding claim, comprising: (a) forming a mixture of said polypropylene-based polymer and said density reduction agent; and (b1) extruding said mixture to form a polymeric layer; or (b2) co-extruding said mixture with additional polymeric material to form a multilayer film.
36. In some embodiments according to paragraph 35, the process further comprises a step of orienting said film in machine direction, traverse direction or both to form a film having a haze ≦20% and a density (D)≦0.85 g/cm³, particularly wherein the polypropylene-based polymer has a refractive index (R₁), said method comprising a step of selecting a density reduction agent having a refractive index (R₂) such that the ratio of R₁ over R₂ (R₁/R₂) is within a range selected from the group consisting of 1±0.25, 1±0.2, 1±0.1, 1±0.05, 1±0.025, 1±0.01, and 1±0.005, more particularly wherein said orientation step is by a process selected from the group consisting of tenter frame process, simultaneous machine and transverse direction orientation, double bubble process, and combinations thereof.

### EXAMPLES

Hollow glass spheres of grade 110P8, manufactured by Potter Industries, Inc., were used as the density reduction agent in the following Examples. These hollow glass spheres have the following properties: density of 1.1 g/cm³; mean diameter of 11 μm; white color; Moh's scale hardness of 6; and, crush strength of >10,000 psi. The glass spheres were added as a masterbatch (Glass Spheres MB) comprised of 50 wt. % 110P8 and 50 wt. % polypropylene (Total 3371).

The ethylene-propylene-1-butene terpolymers were JPC 7510 and JPC 7880, obtained from Japan Polychem Corporation of Japan. Polypropylene resin was Total 3371, obtained from Total of France. The silicon oil is Dow Corning 200.

A number of five-layer coextruded films (ADBDC) having a polygauge of approximately 25 μm were prepared having the following general structure: Skin Layer A includes ethylene-propylene-1-butene terpolymer (JPC 7510) with a thickness of 0.75 μm. Core Layer B includes polypropylene homopolymer (Total 3371) with a thickness of 12.8-17.8 μm. Sealant Skin Layer C includes ethylene-propylene-1-butene terpolymer (JPC 7880) with a thickness of 1.5 μm. Tie Layers D located between each of the skin and core layers includes polypropylene homopolymer (Total 3371) with a thickness of 2.5-5.0 μm.

Additional components, such as density reduction agents and wetting agents, of each layer are listed by sample in Table 1. All examples in Table 1 were biaxially oriented approximately 5 times in machine direction and 8 times in transverse direction.

A three-layer, biaxially oriented polypropylene film was used as the Control sample in Table I. The Control sample did not contain a density reduction agent and had a core layer (20.8 μm) comprised of polypropylene, a skin layer (0.5 μm) comprised of ethylene-propylene-1-butene terpolymer, and a sealant layer (1.0 μm) comprised of ethylene-propylene-1-butene terpolymer. Selected representative physical properties of the prepared five-layer film were measured and compared to the Control sample as shown in Table 1.

TABLE 1

| | Percentage | | | | | | |
|---|---|---|---|---|---|---|---|
| | of Additional | | Poly- | Optical | Film | | Gurley |
| | Components (Wt. %) | Yield | Gauge | Gauge | Density | Haze | Stiffness |
| Sample | in Film Layer | (m²/kg) | (μm) | (μm) | (g/cm³) | (%) | (MD/TD) |
| Comp. | None | 48.2 | 22.5 | 22.5 | 0.905 | 2 | 1.3/2.2 |
| Ex. A | | | | | | | |
| 1 | 5% glass spheres + | 41.7 | 26.0 | 50.5 | 0.475 | 88 | 4.4/6.7 |
| | 1.2% silicone oil in | | | | | | |
| | Core Layer | | | | | | |
| 2 | 5% glass spheres + | 43.7 | 24.8 | 51.2 | 0.447 | 90 | 3.4/5.6 |
| | 1.2% silicone oil in | | | | | | |
| | Core Layer and each | | | | | | |
| | Tie Layer | | | | | | |
| 3 | 1% glass spheres + | 43.0 | 25.3 | 35.3 | 0.659 | 31 | 1.9/2.8 |
| | 1.2% silicone oil in | | | | | | |
| | Core Layer | | | | | | |
| 4 | 1% glass spheres + | 46.2 | 23.5 | 26.5 | 0.817 | 5 | 1.5/2.1 |
| | 1.2% silicone oil in | | | | | | |
| | each Tie Layer (2.54 μm) | | | | | | |
| 5 | 1% glass spheres + | 44.0 | 24.8 | 31.8 | 0.715 | 8 | 1.5/2.4 |
| | 1.2% silicone oil in | | | | | | |
| | each Tie Layer (5.08 μm) | | | | | | |
| 6 | 5% glass spheres + | 46.2 | 23.5 | 35.0 | 0.618 | 31 | 1.5/2.0 |
| | 1.2% silicone oil in | | | | | | |
| | each Tie Layer (5.08 μm) | | | | | | |
| 7 | 5% glass spheres + | 48.2 | 22.5 | 34.5 | 0.601 | 20 | 1.6/2.1 |
| | 1.2% silicone oil in | | | | | | |
| | each Tie Layer (2.54 μm) | | | | | | |

A number of additional five-layer coextruded films (ABCBA) having a polygauge of approximately 25 μm were prepared having the following general structures: Two Skin Layers A including ethylene-propylene copolymer (Total 8573HB) with a thickness of 1.0 μm are provided. Core Layer C includes polypropylene homopolymer (ExxonMobil 4612E2) with a thickness of 13-18 μm. Two Tie Layers B including polypropylene homopolymer (ExxonMobil 4612E2) with a thickness of 2.5-5.0 μm are located between each of the Skin Layers A and the Core Layer C.

The presence of additional components, such as density reduction agents (e.g. glass spheres) and wetting agents, of each layer are indicated by sample in Table 2. Any material not listed for a particular layer is substantially absent. All examples in Table 2 were biaxially oriented approximately 5 times in machine direction and 8 times in transverse direction.

The glass spheres were compounded with polypropylene homopolymer (ExxonMobil 4612E2) into a master batch of 2-5 wt. % glass spheres and then blended with polypropylene homopolymer to get desired levels. The composition is essentially free of silicone oil additive (i.e. no silicone oil is purposely added to the polypropylene composition having the glass beads). A Control sample was produced without glass spheres, and includes polypropylene in core layer and both intermediate tie layers, and two ethylene-propylene copolymer skin layers (1.0 μm).

Two comparative examples using PBT (polybutylene terephthalate) as the density reduction or cavitating agent or voiding agent were produced using similar structures. The PBT used was Valox 195, obtained from SABIC Innovative Plastics of Saudi Arabia. Selected representative physical properties of the prepared five-layer films were measured and compared to the Control sample and Comparative samples with PBT, as shown in Table 2.

TABLE 2

| | Percentage of | | | | | |
|---|---|---|---|---|---|---|
| | Additional | | | | | |
| | Components | | Optical | Film | | |
| | (Wt. %) in Film | Yield | Gauge | Density | Haze | Clarity |
| Sample | Layer | (m²/kg) | (μm) | (g/cm³) | (%) | (%) |
| Comp. | None | 41.4 | 26.7 | 0.908 | 1.1 | 98.4 |
| Ex. B | | | | | | |
| 8 | 1% glass spheres | 45.6 | 30.5 | 0.721 | 26.0 | 70.1 |
| | in core layer | | | | | |
| | (18 μm) | | | | | |
| 9 | 2% glass spheres | 43.6 | 30.2 | 0.761 | 13.6 | 76.0 |
| | in each tie layer | | | | | |
| | (5 μm) | | | | | |
| Comp. | 1% PBT in core | 42.4 | 30.0 | 0.788 | 89.6 | 44.3 |
| Ex. C | layer (18 μm) | | | | | |
| Comp. | 2% PBT in each | 42.3 | 27.2 | 0.872 | 59.4 | 85.1 |
| Ex. D | tie layer (5 μm) | | | | | |

The exemplary film of the present invention provides a reduction in the density of multilayer film by the use a density reduction agent while maintaining acceptable haze and yield properties. Compared to using PBT as the density reduction agent, using hollow glass spheres as the density reduction agent resulted in lower film densities and better optical properties. Visually, the films with glass spheres appeared essentially transparent and matte, while the films with PBT were more opaque and looked milky white.

Embodiments of the invention are applicable to polymer films other than polypropylene-based films. For example, a number of five-layer coextruded films (ABCBD) having a polygauge of approximately 25 μm were prepared using LLDPE with the following general structure: Skin Layer A comprising LLPDE (ExxonMobil LL3002.32) and 500 ppm antiblock with a thickness of 1.0 μm, a Core Layer C comprising LLPDE (ExxonMobil LL3002.32) with a thickness of 13-18 μm, Skin Layer D consists of LLPDE (ExxonMobil LL3002.32) with a thickness of 1.0 μm. The structure also includes a first Tie Layer B comprising LLPDE (ExxonMobil LL3002.32) with a thickness of 2.5-5.0 μm located between Skin Layer A and the Core Layer C and a second Tie Layer B of essentially the same composition and thickness interposing the Core Layer C and Skin Layer D. Additional components, such as density reduction agents and wetting agents, present in the respective layers are listed by sample in Table 3. Any material not listed for a particular layer is substantially absent (i.e. not purposely added).

The glass spheres were compounded with LLDPE (ExxonMobil LL3002.32, an ethylene/hexene copolymer suitable for cast films having a density of 0.917 g/cm³, a melt index (ASTM D 1238 2.1 kg/10 min) of 2.0 g/10 min., and peak melting temperature of 124° C.) into a master batch of 2 wt. % glass spheres and then used as is or blended with LLDPE to get desired levels. A Control sample was produced without glass spheres, comprised primarily of LLDPE in all layers. The antiblock used was Sylobloc 45, supplied in a 1 wt. % masterbatch with HDPE, and let down to a level of 500 ppm in the skin layer. All of LLDPE films were biaxially oriented, at somewhat lower level than polypropylene films, at approximately 4 times in the-machine direction-(MD) and 6 times in transverse direction (TD). Selected representative physical properties of the prepared five-layer films were measured and compared to the Control sample, as shown in Table 3.

TABLE 3

| | Percentage | | | | | |
|---|---|---|---|---|---|---|
| | of Additional | | | | | |
| | Components | | Optical | Film | | |
| | (Wt. %) in Film | Yield | Gauge | Density | Haze | Clarity |
| Sample | Layer | (m²/kg) | (μm) | (g/cm³) | (%) | (%) |
| Comp, | None | 43.7 | 25.1 | 0.912 | 2.6 | 99.0 |
| Ex. E | | | | | | |
| 10 | 1% glass spheres | 45.4 | 24.6 | 0.899 | 15.7 | 80.4 |
| | in core layer | | | | | |
| | (18 μm) | | | | | |
| 11 | 2% glass spheres | 43.9 | 26.4 | 0.865 | 12.9 | 83.9 |
| | in each tie layer | | | | | |
| | (5 μm) | | | | | |
| 12 | 2% glass spheres | 49.1 | 26.7 | 0.770 | 34.9 | 59.0 |
| | in core layer | | | | | |
| | (18 μm) | | | | | |
| | and each tie | | | | | |
| | layer (2.5 μm) | | | | | |

Although the amount of density reduction was not as great as in polypropylene films with same levels of glass spheres, the same trend of lower density while maintaining relatively good optical properties was observed. The lower amount of orientation, which was more limited by equipment capabilities with this resin, would also contribute to less overall cavitation. However, these examples illustrate that the concept can be applied equally to other polymeric materials. The exemplary films of the present invention provide a reduction in the density of multi-layer films by the use of a density reduction agent while maintaining acceptable haze and yield properties.

While the invention has been described in detail and with reference to specific embodiments thereof, it will be apparent to one of ordinary skill in the art that various changes and modifications can be made therein without departing from the spirit and scope of the invention. The Examples recited herein are demonstrative only and are not meant to be limiting.

1. A film, comprising one or more polymeric layer(s), wherein at least one of said one or more polymeric layer(s) comprises a polymer and a density reduction agent, wherein the film has a haze ≦35% and a density (D) of at least 1% lower than a comparative film, wherein said polymer is one or more of a homopolymer, copolymer, terpolymer and blends of a polymeric material, said polymeric material selected from the group consisting of a C₂ to C₈ alpha-olefin, a polyamide, a polyacetate, a polyester, a polycarbonate, a polystyrene, a poly(ethylene vinyl alcohol), a poly(vinyl chloride), a poly(vinyl alcohol), a poly(ethylene vinyl acetate), a poly(acrylic acid) and a poly(ethylene terephthalate).

2. The film of claim 1, wherein said polymer has a refractive index (R₁) and said density reduction agent has a refractive index (R₂), the ratio of R₁ over R₂ (R₁/R₂) is within a range selected from the group consisting of 1±0.25, 1±0.2, 1±0.1, 1±0.05, 1±0.025, 1±0.01, and 1±0.005.

3. The film of claim 1, wherein said polymeric layer which comprises said polymer and said density reduction agent has ≦20 wt. %, 10 wt. %, 5 wt. %, or 1 wt. % of said density reduction agent based on the weight of said polymeric layer which comprises said polymer and said density reduction agent.

4. The film of claim 1, wherein said density reduction agent comprises particles having an interior volume and a shape, said interior volume of said particles is substantially solid or substantially hollow, said shape of said particle is substantially spherical, tubular or irregular.

5. The film of claim 4, wherein said density reduction agent particles comprise polymer, glass, ceramic or metal or a combination thereof.

6. The film of claim 5, wherein said density reduction agent is a substantially spherical particle having a mean diameter of ≦a mean diameter value selected from a group consisting of 20 μm, 15 μm, 10 μm, 5 μm, and 1 μm.

7. The film of claim 1, wherein said haze of said the film is ≦30%.

8. The film of claim 1, wherein said density (D) of the film is ≦90% of the density of a comparative film.

9. The film of claim 1, wherein said density (D) of the film is ≦50% of the density of a comparative film.

10. The film of claim 1, further comprising a wetting agent, wherein said wetting agent is in contact with at least a portion of said density reduction agent.

11. The film of claim 10, wherein said wetting agent is selected from the group consisting of a silicone oil, a mineral oil, erucamide, a silicone gum, a surfactant and combinations thereof.

12. The film of claim 10, wherein said wetting agent comprises a silane.

13. The film of claim 11, wherein said surfactant is an anionic surfactant, a cationic surfactant, a non-ionic surfactant, a zwitterionic (dual charge) surfactant or a combination thereof.

14. The film of claim 1, wherein said one or more polymeric layer(s) further comprises one or more of a homopolymer, copolymer, terpolymer and blends of a polymeric material, said polymeric material selected from the group consisting of a C₂ to C₈ alpha-olefin, a polyamide, a polyacetate, a polyester, a polycarbonate, a polystyrene, a poly(vinyl chloride), a poly(ethylene vinyl alcohol), a poly(vinyl alcohol), a poly(ethylene vinyl acetate), a poly(acrylic acid) and a poly(ethylene terephthalate).

15. The film of claim 1, further comprising at least one additional layer disposed on an outermost surface of said one or more polymeric layer(s).

16. The film of claim 15, wherein said additional layer is selected from the group consisting of a skin layer, a heat sealing layer, a laminatable layer, a printable layer and combinations thereof, wherein said additional layer comprises a paper, a vacuum-deposited metal foil, a protective coating, a heat sealing coating, a laminatable coating, an adhesive coating, a primer coating, a printable coating, a polymeric material or a combination thereof.

17. The film of claim 1, wherein the polymer of the at least one polymeric layer comprises a polypropylene-based polymer and wherein said film has a haze ≦20% and a density (D)≦0.85 g/cm³.

18. The film of claim 17, wherein the haze is ≦5%.

19. The film claim 1 having a density of from 0.65 to 0.85 g/cm³.

20-21. (canceled)

22. A method for making the film comprising:
(a) forming a mixture comprising said polymer and said density reduction agent;
(b1) extruding said mixture to form a polymeric layer; or
(b2) co-extruding said mixture with additional polymeric material to form a multilayer film; and
(c) orienting said film in machine direction, transverse direction or both to form a film having a haze ≦35% and a density (D)≦99% of the density of a comparative film.

23-25. (canceled)
